(19) United States
(12) Patent Application Publication
(10) Pub. No.: US 2026/0244003 A1
(43) Pub. Date: Aug. 20, 2026

(54) WIDE-ANGLE LENS ASSEMBLY

(71) Applicant: Asia Optical Co., Inc., Taichung (TW)

(72) Inventor: An-Kai Chang, Taichung (TW)

(21) Appl. No.: 19/530,581

(22) Filed: Feb. 5, 2026

(30) Foreign Application Priority Data
Feb. 17, 2025 (TW) 114105745

(51) Int. Cl. G02B 13/06; G02B 9/62; G02B 13/00

(52) U.S. Cl. CPC G02B 13/06; G02B 9/62; G02B 13/0045; G02B 13/0055

(57) ABSTRACT

A wide-angle lens assembly includes a first lens, a second lens, a third lens, a fourth lens, a fifth lens, and a sixth lens. The first lens is with negative refractive power and includes a concave surface facing an image side. The second lens is with refractive power. The third lens is a biconvex lens with positive refractive power and includes a convex surface facing an object side and another convex surface facing the image side. The fourth lens is with positive refractive power and includes a convex surface facing the object side. The fifth lens is with negative refractive power. The sixth lens is with refractive power. The first lens, the second lens, the third lens, the fourth lens, the fifth lens, and the sixth lens are arranged in order from the object side to the image side along an optical axis.

### BACKGROUND OF THE INVENTION

### Field of the Invention

The present invention relates to a wide-angle lens assembly.

### Description of the Related Art

The current development trend of a wide-angle lens assembly is toward large field of view. Additionally, the wide-angle lens assembly is required to feature a large aperture, high resolution, resistance to environmental temperature changes, and the capability for simultaneous imaging in both visible and infrared spectra to satisfy diverse application requirements. However, the known wide-angle lens assembly can't satisfy such requirements. Therefore, the wide-angle lens assembly requires a new structure to simultaneously meet the requirements of large field of view, large aperture, high resolution, resistance to environmental temperature changes, and the capability for imaging in both visible and infrared spectra.

### BRIEF SUMMARY OF THE INVENTION

The present invention provides a wide-angle lens assembly to address the needs in the related art. The wide-angle lens assembly of the present invention is provided with characteristics of an increased field of view, large aperture, high resolution, resistance to environmental temperature changes, and the capability for imaging in both visible and infrared spectra.

The wide-angle lens assembly in accordance with an exemplary embodiment of the invention includes a first lens, a second lens, a third lens, a fourth lens, a fifth lens, and a sixth lens. The first lens has negative refractive power and includes a concave surface facing an image side. The second lens has refractive power. The third lens is a biconvex lens with positive refractive power and includes a convex surface facing an object side and another convex surface facing the image side. The fourth lens has positive refractive power and includes a convex surface facing the object side. The fifth lens has negative refractive power. The sixth lens has refractive power. The first lens, the second lens, the third lens, the fourth lens, the fifth lens, and the sixth lens are arranged in order from the object side to the image side along an optical axis. The wide-angle lens assembly satisfies at least one of the following conditions: 50.59≤(R11+R12)/T1≤91.89; −10.05≤(R51+R52)/T5≤0.51; 3.85 mm≤T4+T5+T6≤4.41 mm; 55.18 degrees/mm≤FOV/f≤60.73 degrees/mm; wherein f is an effective focal length of the wide-angle lens assembly, T1 is an interval from an object side surface of the first lens to an image side surface of the second lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R11 is a radius of curvature of the object side surface of the first lens, R12 is a radius of curvature of an image side surface of the first lens, R51 is a radius of curvature of the object side surface of the fifth lens, R52 is a radius of curvature of the image side surface of the fifth lens, and FOV is a full field of view of the wide-angle lens assembly. When the wide-angle lens assembly of the present invention meets the above characteristics and at least one of the conditions without requiring other additional characteristics or conditions, the basic functions of the lens assembly of the present invention can be achieved.

In another exemplary embodiment, the second lens is with negative refractive power, the sixth lens is with positive refractive power.

In yet another exemplary embodiment, the first lens is a meniscus lens and includes a convex surface facing the object side, the second lens is a meniscus lens, the fourth lens is a biconvex lens and includes a convex surface facing the image side, the fifth lens includes a concave surface facing the object side, the sixth lens includes a convex surface facing the object side.

In another exemplary embodiment, the second lens includes a convex surface facing the object side and a concave surface facing the image side, the fifth lens is a biconcave lens and includes a concave surface facing the image side.

In yet another exemplary embodiment, the sixth lens is a biconvex lens and includes a convex surface facing the image side.

In another exemplary embodiment, the wide-angle lens assembly satisfies at least one of the following conditions: −1.55≤f1/f≤−1.2; 1.1≤f4/f≤1.6; 0.25≤(T3+T4)/TTL≤0.38; 0.005≤(d23+d45)/TTL≤0.04; 0.43≤(R31+R32)/T3≤4.05; 9.97≤TTL/d12≤11.71; 13.27≤TTL/d56≤26.79; 1.76≤f/(d12+d23)≤3.18; wherein f is an effective focal length of the lens assembly, f1 is an effective focal length of the first lens, f4 is an effective focal length of the fourth lens, TTL is an interval from an object side surface of the first lens to the image plane along the optical axis, T3 is an interval from an object side surface of the third lens to an image side surface of the third lens along the optical axis, T4 is an interval from an object side surface of the fourth lens to an image side surface of the fourth lens along the optical axis, d12 is an air interval from an image side surface of the first lens to an object side surface of the second lens along the optical axis, d23 is an air interval from an image side surface of the second lens to the object side surface of the third lens along the optical axis, d45 is an air interval from the image side surface of the fourth lens to an object side surface of the fifth lens along the optical axis, and d56 is an air interval from an image side surface of the fifth lens to an object side surface of the sixth lens along the optical axis.

In yet another exemplary embodiment, the sixth lens is a meniscus lens and includes a concave surface facing the image side.

In another exemplary embodiment, the second lens includes a concave surface facing the object side and a convex surface facing the image side, the fifth lens is a meniscus lens and includes a convex surface facing the image side.

In yet another exemplary embodiment, the wide-angle lens assembly further includes a stop disposed between the second lens and the third lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1, 5, 9 are lens layout diagrams of a wide-angle lens assembly in accordance with a first, a second, and a third embodiments of the invention, respectively;

FIGS. 2, 3, 4 depict a longitudinal aberration diagram, a field curvature diagram, and a distortion diagram of the wide-angle lens assembly in accordance with the first embodiment of the invention, respectively;

FIGS. 6, 7, 8 depict a longitudinal aberration diagram, a field curvature diagram, and a distortion diagram of the wide-angle lens assembly in accordance with the second embodiment of the invention, respectively; and

FIGS. 10, 11, 12 depict a longitudinal aberration diagram, a field curvature diagram, and a distortion diagram of the wide-angle lens assembly in accordance with the third embodiment of the invention, respectively.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a wide-angle lens assembly including a first lens, a second lens, a third lens, a fourth lens, a fifth lens, and a sixth lens. The first lens having negative refractive power and includes a concave surface facing an image side. The second lens having refractive power. The third lens is a biconvex lens with positive refractive power and includes a convex surface facing an object side and another convex surface facing the image side. The fourth lens having positive refractive power and includes a convex surface facing the object side. The fifth lens having negative refractive power. The sixth lens having refractive power. The first lens, the second lens, the third lens, the fourth lens, the fifth lens, and the sixth lens are arranged in order from the object side to the image side along an optical axis. The wide-angle lens assembly satisfies at least one of the following conditions: 50.59≤(R11+R12)/T1≤91.89; −10.05≤(R51+R52)/T5≤0.51; 3.85 mm≤T4+T5+T6≤4.41 mm; 55.18 degrees/mm≤FOV/f≤60.73 degrees/mm; wherein f is an effective focal length of the wide-angle lens assembly, T1 is an interval from an object side surface of the first lens to an image side surface of the second lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R11 is a radius of curvature of the object side surface of the first lens, R12 is a radius of curvature of an image side surface of the first lens, R51 is a radius of curvature of the object side surface of the fifth lens, R52 is a radius of curvature of the image side surface of the fifth lens, and FOV is a full field of view of the wide-angle lens assembly. A wide-angle lens assembly of the present invention is a preferred embodiment of the present invention when the wide-angle lens assembly satisfies the above features and at least one of the above conditions.

Referring to Table 1, Table 2, Table 4, Table 5, Table 7, and Table 8, wherein Table 1, Table 4, and Table 7 show optical specification in accordance with a first, second, and third embodiments of the invention, respectively and Table 2, Table 5, and Table 8 show aspheric coefficients of each aspheric lens in Table 1, Table 4, and Table 7, respectively. The aspheric surface sag z of each aspheric lens in the following embodiments can be calculated by the following formula: z=z=ch²/{1+[1−(k+1)c² h²]^{1/2}}+Ah⁴+Bh⁶+Ch⁸+Dh¹⁰+Eh¹², where c is curvature, h is the vertical distance 135 from the lens surface to the optical axis, k is conic constant, A, B, C, D, and E are aspheric coefficients, and the value of the aspheric coefficient A, B, C, D, and E are presented in scientific notation, such as 2E-03 for 2×10⁻³.

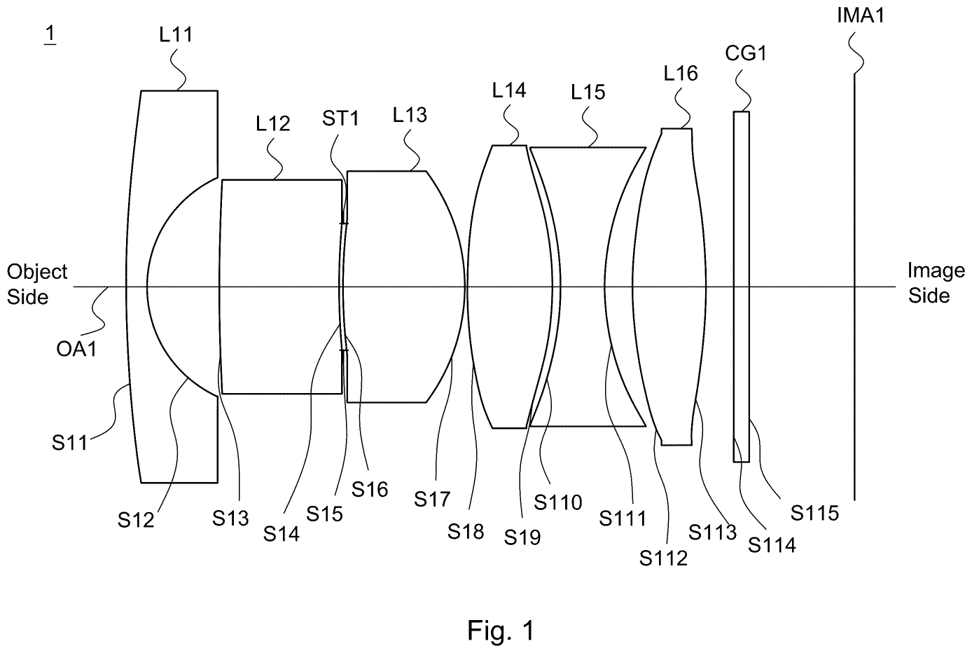

FIGS. 1, 5, and 9 are lens layout diagrams of the wide-angle lens assemblies in accordance with the first, second, and third embodiments of the invention, respectively.

The first lenses L11, L21, and L31 are meniscus lenses with negative refractive power, wherein the object side surfaces S11, S21, and S31 are convex surfaces, the image side surfaces S12, S22, and S32 are concave surfaces.

The second lenses L12, L22, and L32 are meniscus lenses with negative refractive power and made of plastic material, wherein the object side surfaces S13, S23, S33 and the image side surfaces S14, S24, S34 are aspheric surfaces.

The third lenses L13, L23, and L33 are biconvex lenses with positive refractive power and made of plastic material, wherein the object side surfaces S16, S26, and S36 are convex surfaces, the image side surfaces S17, S27, and S37 are convex surfaces, and both of the object side surfaces S16, S26, S36 and the image side surfaces S17, S27, S37 are aspheric surfaces.

The fourth lenses L14, L24, and L34 are biconvex lenses with positive refractive power and made of plastic material, wherein the object side surfaces S18, S28, and S38 are convex surfaces, the image side surfaces S19, S29, and S39 are convex surfaces, and both of the object side surfaces S18, S28, S38 and the image side surfaces S19, S29, S39 are aspheric surfaces.

The fifth lenses L15, L25, and L35 are with negative refractive power and made of plastic material, wherein the object side surfaces S110, S210, and S310 are concave surfaces, and both of the object side S110, S210, S310 and the image side surfaces S111, S211, S311 are aspheric surfaces.

The sixth lenses L16, L26, and L36 are with positive refractive power and made of plastic material, wherein the object side surfaces S112, S212, and S312 are convex surfaces, and both of the object side S112, S212, S312 and the image side surfaces S113, S213, S313 are aspheric surfaces.

In addition, the wide-angle lens assemblies 1, 2, and 3 satisfy at least one of the following conditions (1)-(12):

$$- 1.55 \leq f 1 / f \leq - 1.2 ; \qquad ( 1 )$$

$$1.1 \leq f 4 / f \leq 1.6 ; \qquad ( 2 )$$

$$0.25 \leq ( T 3 + T 4 ) / TTL \leq 0 \text{.38} ; \qquad ( 3 )$$

$$0.005 \leq ( d 23 + d 45 ) / TTL \leq 0 \text{.04} ; \qquad ( 4 )$$

$$50.59 \leq ( R 11 + R 12 ) / T 1 \leq 91.89 ; \qquad ( 5 )$$

$$0.43 \leq ( R 31 + R 32 ) / T 3 \leq 4 \text{.05} ; \qquad ( 6 )$$

$$- 10. 05 \leq ( R 51 + R 52 ) / T 5 \leq 0 \text{.51} ; \qquad ( 7 )$$

$$9.97 \leq TTL / d 12 \leq 11.71 ; \qquad ( 8 )$$

$$13.27 \leq TTL / d 56 \leq 26 \text{.79} ; \qquad ( 9 )$$

$$3.85 mm \leq T 4 + T 5 + T 6 \leq 4.41 mm ; \qquad ( 10 )$$

$$1.76 \leq f / ( d 12 + d 23 ) \leq 3 \text{.18} ; \qquad ( 11 )$$

$$55.18 degrees / mm \leq FOV / f \leq 60.73 degrees / mm ; \qquad ( 12 )$$

wherein the parameters in the first to third embodiments are defined as follows: f1 is an effective focal length of the first lenses L11, L21, L31; f4 is an effective focal length of the fourth lenses L14, L24, L34; f is an effective focal length of the wide-angle lens assemblies 1, 2, 3; T1 is an interval from the object side surfaces S11, S21, S31 of the first lens L11, L21, L31 to the image side surfaces S12, S22, S32 of the first lens L11, L21, L31 along the optical axes OA1, OA2, OA3; T3 is an interval from the object side surfaces S16, S26, S36 of the third lens L13, L23, L33 to the image side surfaces S17, S27, S37 of the third lens L13, L23, L33 along the optical axes OA1, OA2, OA3; T4 is an interval from the object side surfaces S18, S28, S38 of the fourth lens L14, L24, L34 to the image side surfaces S19, S29, S39 of the fourth lens L14, L24, L34 along the optical axes OA1, OA2, OA3; T5 is an interval from the object side surfaces S110, S210, S310 of the fifth lens L15, L25, L35 to the image side surfaces S111, S211, S311 of the fifth lens L15, L25, L35 along the optical axes OA1, OA2, OA3; T6 is an interval from the object side surfaces S112, S212, S312 of the sixth lens L16, L26, L36 to the image side surfaces S113, S213, S313 of the sixth lens L16, L26, L36 along the optical axes OA1, OA2, OA3; R11 is a radius of curvature of the object side surfaces S11, S21, S31 of the first lens L11, L21, L31; R12 is a radius of curvature of the image side surfaces S12, S22, S32 of the first lens L11, L21, L31; R31 is a radius of curvature of the object side surfaces S16, S26, S36 of the third lens L13, L23, L33; R32 is a radius of curvature of the image side surfaces S17, S27, S37 of the first lens L13, L23, L33; R51 is a radius of curvature of the object side surfaces S110, S210, S310 of the fifth lens L15, L25, L35; R52 is a radius of curvature of the image side surfaces S111, S211, S311 of the fifth lens L15, L25, L35; d12 is an air interval from the image side surfaces S12, S22, S32 of the first lens L11, L21, L31 to the object side surfaces S13, S23, S33 of the second lens L12, L22, L32 along the optical axes OA1, OA2, OA3; d23 is an air interval from the image side surfaces S14, S24, S34 of the second lens L12, L22, L32 to the object side surfaces S16, S26, S36 of the third lens L13, L23, L33 along the optical axes OA1, OA2, OA3; d45 is an air interval from the image side surfaces S19, S29, S39 of the fourth lens L14, L24, L34 to the object side surfaces S110, S210, S310 of the fifth lens L15, L25, L35 along the optical axes OA1, OA2, OA3; d56 is an air interval from the image side surfaces S111, S211, S311 of the fifth lens L15, L25, L35 to the object side surfaces S112, S212, S312 of the sixth lens L16, L26, L36 along the optical axes OA1, OA2, OA3; TTL is an interval from the object side surfaces S11, S21, S31 of the first lenses L11, L21, L31 to the image planes IMA1, IMA2, IMA3 along the optical axes OA1, OA2, OA3; and FOV is a full field of view of the wide-angle lens assemblies 1, 2, 3. With the wide-angle lens assemblies 1, 2, 3 satisfying at least one of the above conditions (1)-(12), the total lens length can be effectively shortened, the field of view can be effectively increased, the environment temperature change can be effectively resisted, and the aberration can be effectively corrected.

When the condition (1), (5), (6), (7), (10), and (12): −1.55≤f1/f≤−1.2, 50.59≤(R11+R12)/T1≤91.89, 0.43≤(R31+R32)/T3≤4.05, −10.05≤(R51+R52)/T5≤0.51, 3.85 mm≤T4+T5+T6≤4.41 mm, and 55.18 degrees/mm≤FOV/f≤60.73 degrees/mm are satisfied, the total lens length of the wide-angle lens assembly can be effectively 220 shortened.

A detailed description of a wide-angle lens assembly in accordance with a first embodiment of the invention is as follows. Referring to FIG. 1, the wide-angle lens assembly 1 includes a first lens L11, a second lens L12, a stop ST1, a third lens L13, a fourth lens L14, a fifth lens L15, a sixth lens L16, and an cover glass CG1, all of which are arranged in order from an object side to an image side along an optical axis OA1. In operation, the light from the object side is imaged on an image plane IMA1.

According to the foregoing, wherein: both of the object side surface S11 and image side surface S12 of the first lens L11 are spherical surface; the second lens L12 is a meniscus lens, wherein the object side surface S13 is a convex surface and the image side surface S14 is a concave surface; the fifth lens L15 is a biconcave lens, wherein the image side surface S111 is a concave surface; the sixth lens L16 is a biconvex lens, wherein the image side surface S113 is a convex surface; and both of the object side surface S114 and image side surface S115 of the cover glass CG1 are plane surfaces; with the above design of the lenses, stop ST1, and at least one of the conditions (1)-(12) satisfied, the wide-angle lens assembly 1 can have an effective decreased total lens length, an effective increased field of view, an effective resisted environment temperature change, and an effective corrected aberration. The wide-angle lens assembly of the present invention can meet the basic operation requirements when it only satisfies condition (1), the first lens is with negative refractive power includes a concave surface facing the image side, the second lens is with refractive power, the third lens is a biconvex lens with positive refractive power, the fourth lens is with positive refractive power includes a convex surface facing the object side, the fifth lens is with negative refractive power, and the sixth lens is with refractive power.

Table 1 shows the optical specification of the wide-angle lens assembly 1 in FIG. 1.

TABLE 1
Effective Focal Length = 2.68 mm F-number = 2.20
Total Lens Length = 13.93 mm Field of View = 160.20 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S11 | 20.35 | 0.39 | 1.62 | 63.40 | −3.59 | L11 |
| S12 | 1.99 | 1.39 | | | | |
| S13 | 29.62 | 2.29 | 1.63 | 23.30 | −30.97 | L12 |
| S14 | 11.49 | 0.08 | | | | |
| S15 | ∞ | −0.01 | | | | ST1 |
| S16 | 7.98 | 2.33 | 1.54 | 56.00 | 4.35 | L13 |
| S17 | −3.03 | 0.04 | | | | |
| S18 | 6.76 | 1.63 | 1.77 | 49.50 | 3.97 | L14 |
| S19 | −5.07 | 0.16 | | | | |
| S110 | −4.71 | 0.84 | 1.63 | 23.30 | −3.08 | L15 |
| S111 | 3.60 | 0.53 | | | | |
| S112 | 5.91 | 1.41 | 1.54 | 56.00 | 6.64 | L16 |
| S113 | −8.29 | 0.53 | | | | |
| S114 | ∞ | 0.30 | 1.52 | 64.20 | | CG1 |
| S115 | ∞ | 2.01 | | | | |

In the first embodiment, the conic constant k and the aspheric coefficients A, B, C, D, E of each aspheric lens are shown in Table 2.

TABLE 2

| Surface | | | | | | |
|---|---|---|---|---|---|---|
| Number | k | A | B | C | D | E |
| S13 | 0 | −5.742E−04 | 1.201E−04 | | 0 | 0 |
| S14 | 0 | −1.917E−03 | 3.039E−03 | −1.347E−03 | 0 | 0 |
| S16 | 0 | −7.540E−03 | 2.328E−03 | −1.353E−03 | 0 | 0 |
| S17 | 0 | −1.450E−03 | 6.267E−04 | 2.341E−04 | −7.857E−05 | 0 |
| S18 | 0 | −3.385E−03 | 6.981E−04 | 0 | 0 | 0 |
| S19 | 0 | −1.358E−03 | 5.749E−04 | 4.001E−05 | 0 | 0 |
| S110 | 1.233E+00 | −2.718E−03 | 3.676E−03 | −7.475E−04 | 5.614E−05 | 0 |
| S111 | 0 | −1.083E−02 | 3.483E−03 | −6.287E−04 | 4.095E−05 | 0 |
| S112 | 2.333E+00 | −7.100E−03 | 6.098E−04 | −2.279E−05 | 0 | 0 |
| S113 | 0 | 2.255E−03 | −3.754E−05 | −6.440E−06 | 4.392E−06 | 0 |

Table 3 shows the parameters and condition values for conditions (1)-(12) in accordance with the first embodiment of the invention. It can be seen from Table 3 that the lens assembly 1 of the first embodiment satisfies the conditions (1)-(12).

TABLE 3

| T1 | 0.39 mm | T3 | 2.33 mm | T4 | 1.63 | mm |
|---|---|---|---|---|---|---|
| T5 | 0.84 mm | T6 | 1.41 mm | d12 | 1.39 | mm |
| d23 | 0.08 mm | d45 | 0.16 mm | d56 | 0.53 | mm |
| f1/f | −1.34 | f4/f | 1.49 | (T3 + T4)/TTL | 0.28 | |
| (d23 + d45)/TTL | 0.02 | (R11 + R12)/T1 | 56.70 | (R31 + R32)/T3 | 2.12 | |
| (R51 + R52)/T5 | −1.32 | TTL/d12 | 10.05 | TTL/d56 | 26.17 | |
| T4 + T5 + T6 | 3.88 mm | f/(d12 + d23) | 1.83 | FOV/f | 59.89 | degrees/mm |

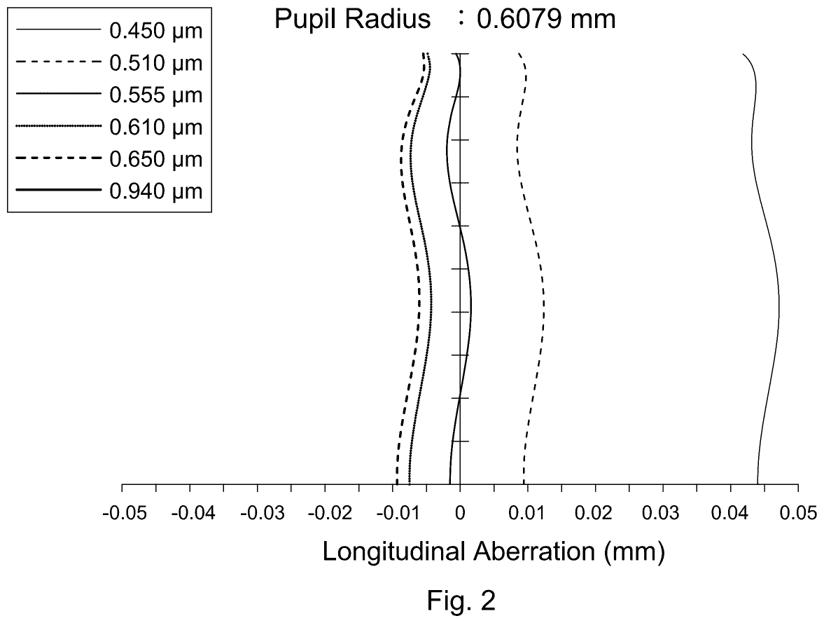

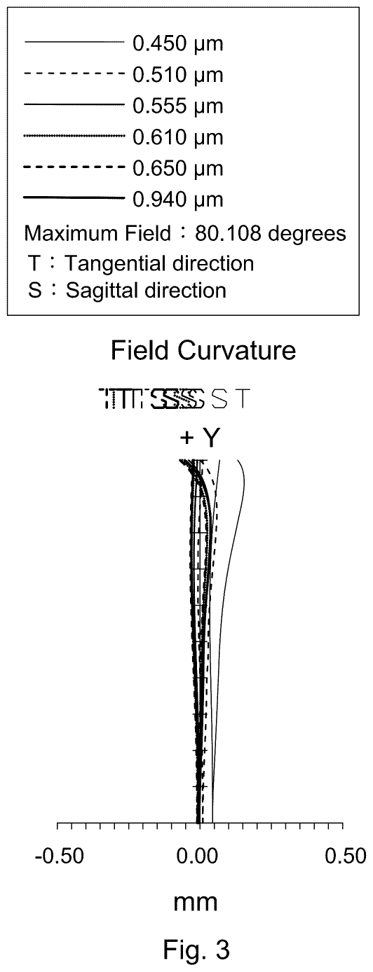

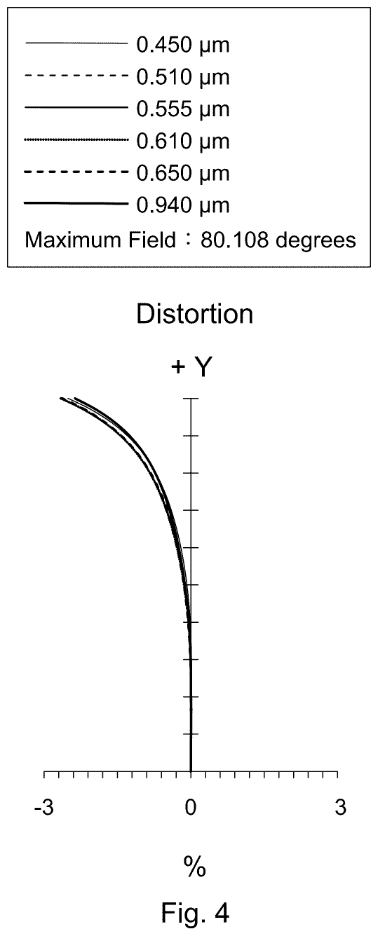

In addition, the wide-angle lens assembly 1 of the first embodiment can meet the requirements of optical performance as seen in FIGS. 2-4. It can be seen from FIG. 2 that the longitudinal aberration in the wide-angle lens assembly 1 of the first embodiment ranges from −0.01 mm to 0.05 mm. It can be seen from FIG. 3 that the field curvature of tangential direction and sagittal direction in the wide-angle lens assembly 1 of the first embodiment ranges from −0.1 mm to 0.2 mm. It can be seen from FIG. 4 that the distortion in the wide-angle lens assembly 1 of the first embodiment ranges from −2.7% to 0%. It is obvious that the longitudinal aberration, the field curvature, the distortion, and the lateral color can be corrected effectively for the wide-angle lens assembly 1 of the first embodiment. Therefore, the wide-angle lens assembly 1 of the first embodiment is capable of good optical performance.

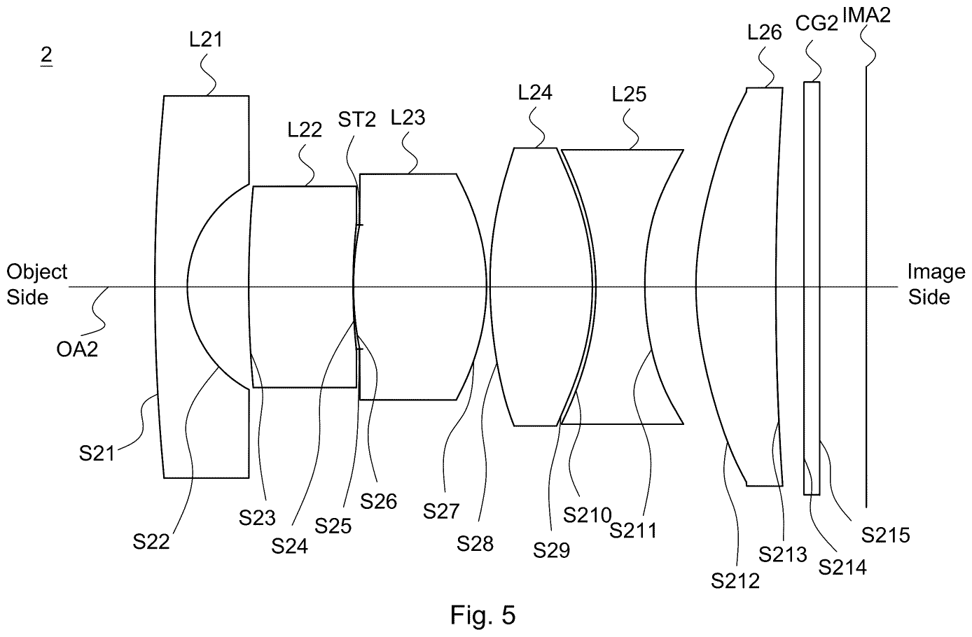

A detailed description of a wide-angle lens assembly in accordance with a second embodiment of the invention is as follows. Referring to FIG. 5, the wide-angle lens assembly 2 includes a first lens L21, a second lens L22, a stop ST2, a third lens L23, a fourth lens L24, a fifth lens L25, a sixth lens L26, and an cover glass CG2, all of which are arranged in order from an object side to an image side along an optical axis OA2. In operation, the light from the object side is imaged on an image plane IMA2.

According to the foregoing, wherein: both of the object side surface S21 and image side surface S22 of the first lens L21 are spherical surfaces; the second lens L22 is a meniscus lens, wherein the object side surface S23 is a convex surface and the image side surface S24 is a concave surface; the fifth lens L25 is a biconcave lens, wherein the image side surface S211 is a concave surface; the sixth lens L26 is a meniscus lens, wherein the image side surface S213 is a concave surface; and both of the object side surface S214 and image side surface S215 of the cover glass CG2 are plane surfaces; with the above design of the lenses, stop ST2, and at least one of the conditions (1)-(12) satisfied, the wide-angle lens assembly 2 can have an effective decreased total lens length, an effective increased field of view, an effective resisted environment temperature change, and an effective corrected aberration. The wide-angle lens assembly of the present invention can meet the basic operation requirements when it only satisfies conditions (5), (6), (7), or (10), the first lens is with negative refractive power includes a concave surface facing the image side, the second lens is with refractive power, the third lens is a biconvex lens with positive refractive power, the fourth lens is with positive refractive power includes a convex surface facing the object side, the fifth lens is with negative refractive power, and the sixth lens is with refractive power.

Table 4 shows the optical specification of the wide-angle lens assembly 2 in FIG. 5.

TABLE 4
Effective Focal Length = 2.67 mm F-number = 2.20
Total Lens Length = 13.49 mm Field of View = 161.20 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S21 | 30.75 | 0.62 | 1.62 | 63.40 | −3.29 | L21 |
| S22 | 1.90 | 1.16 | | | | |
| S23 | 18.36 | 1.97 | 1.63 | 23.30 | −25.77 | L22 |
| S24 | 8.31 | 0.12 | | | | |
| S25 | ∞ | −0.11 | | | | ST2 |
| S26 | 4.84 | 2.52 | 1.54 | 56.00 | 4.06 | L23 |
| S27 | −3.34 | 0.06 | | | | |
| S28 | 5.79 | 1.94 | 1.77 | 49.50 | 3.36 | L24 |
| S29 | −4.03 | 0.07 | | | | |
| S210 | −4.15 | 0.93 | 1.63 | 23.30 | −3.13 | L25 |
| S211 | 4.18 | 0.97 | | | | |
| S212 | 4.68 | 1.52 | 1.54 | 56.00 | 9.57 | L26 |
| S213 | 45.29 | 0.53 | | | | |
| S214 | ∞ | 0.30 | 1.52 | 64.20 | | CG2 |
| S215 | ∞ | 0.89 | | | | |

In the second embodiment, the conic constant k and the aspheric coefficients A, B, C, D, E of each aspheric lens are shown in Table 5.

TABLE 5

| Surface | | | | | | |
|---|---|---|---|---|---|---|
| Number | k | A | B | C | D | E |
| S23 | 0 | −1.05E−04 | 0 | 0 | 0 | 0 |
| S24 | 0 | −1.09E−03 | 2.67E−03 | −1.63E−03 | 0 | 0 |
| S26 | 0 | −3.35E−03 | 2.66E−03 | −1.45E−03 | 0 | 0 |
| S27 | 0 | −2.88E−03 | 9.56E−04 | 3.96E−04 | −7.59E−05 | 0 |
| S28 | 0 | −4.22E−03 | 5.15E−04 | 0 | 0 | 0 |
| S29 | 0 | −9.37E−04 | 5.12E−04 | 2.59E−05 | 0 | 0 |
| S210 | 1.48E+00 | −3.54E−03 | 5.08E−03 | −1.00E−03 | 8.37E−05 | 0 |
| S211 | 0 | −7.86E−03 | 4.59E−03 | −8.40E−04 | 5.39E−05 | 0 |
| S212 | 3.79E−01 | −7.31E−03 | 4.57E−04 | −1.87E−05 | 0 | 0 |
| S213 | 0 | 1.55E−03 | −5.14E−04 | 4.77E−05 | −1.26E−06 | 0 |

Table 6 shows the parameters and condition values for conditions (1)-(12) in accordance with the second embodiment of the invention. It can be seen from Table 6 that the lens assembly 2 of the second embodiment satisfies the conditions (1)-(12).

TABLE 6

| T1 | 0.62 mm | T3 | 2.52 mm | T4 | 1.94 | mm |
|---|---|---|---|---|---|---|
| T5 | 0.93 mm | T6 | 1.52 mm | d12 | 1.16 | mm |
| d23 | 0.02 mm | d45 | 0.07 mm | d56 | 0.97 | mm |
| f1/f | −1.23 | f4/f | 1.26 | (T3 + T4)/TTL | 0.33 | |
| (d23 + d45)/TTL | 0.01 | (R11 + R12)/T1 | 52.47 | (R31 + R32)/T3 | 0.60 | |
| (R51 + R52)/T5 | 0.03 | TTL/d12 | 11.63 | TTL/d56 | 13.89 | |
| T4 + T5 + T6 | 4.38 mm | f/(d12 + d23) | 2.27 | FOV/f | 60.47 | degrees/mm |

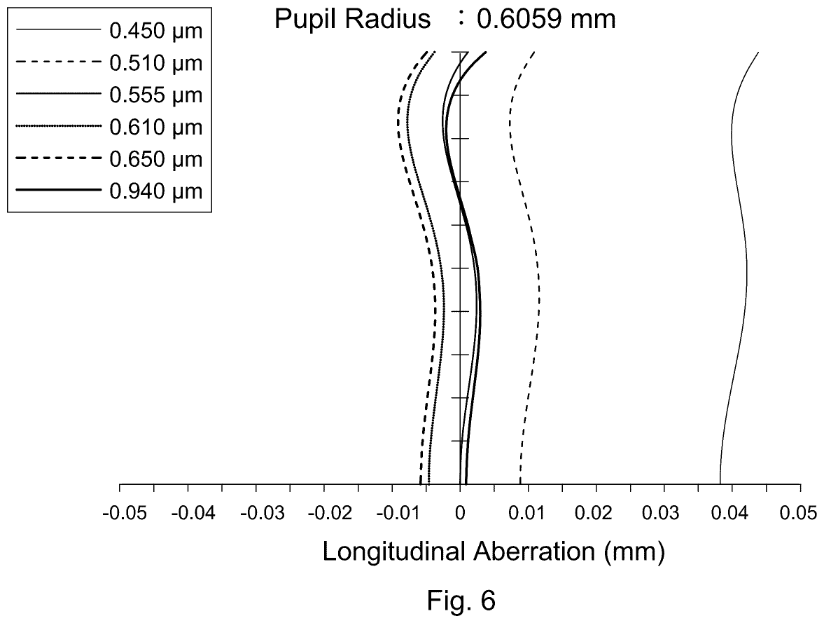

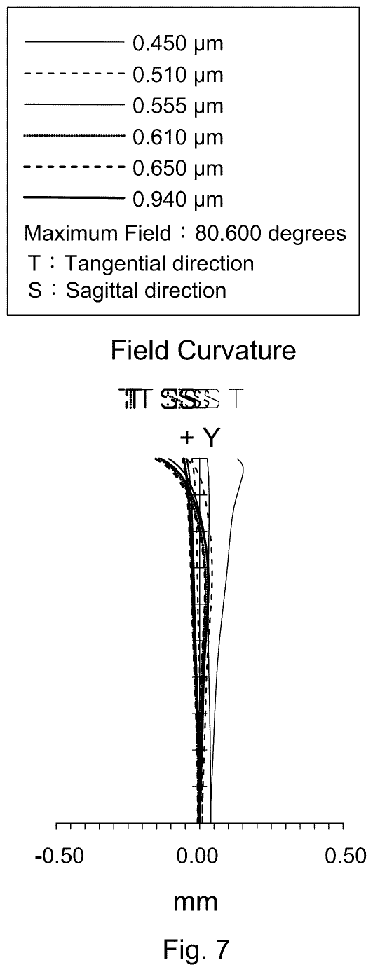

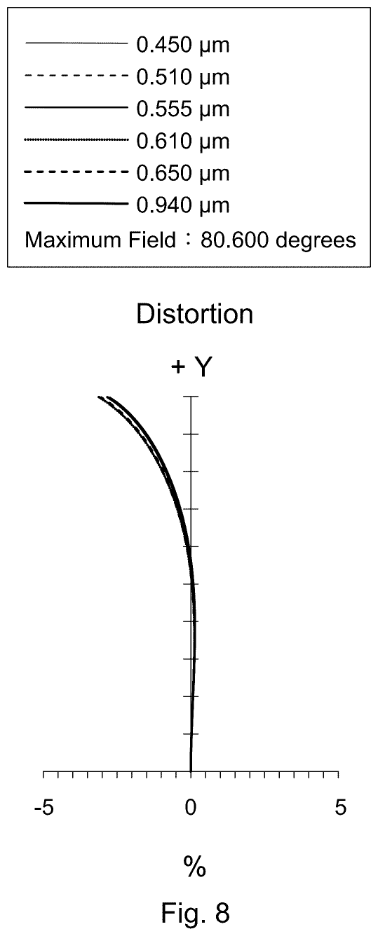

In addition, the wide-angle lens assembly 2 of the second embodiment can meet the requirements of optical performance as seen in FIGS. 6-8. It can be seen from FIG. 6 that the longitudinal aberration in the wide-angle lens assembly 2 of the second embodiment ranges from −0.01 mm to 0.045 mm. It can be seen from FIG. 7 that the field curvature of tangential direction and sagittal direction in the wide-angle lens assembly 2 of the second embodiment ranges from −0.2 mm to 0.15 mm. It can be seen from FIG. 8 that the distortion in the wide-angle lens assembly 2 of the second embodiment ranges from −3.5% to 0.5%. It is obvious that the longitudinal aberration, the field curvature, the distortion, and the lateral color can be corrected effectively for the wide-angle lens assembly 2 of the second embodiment. Therefore, the wide-angle lens assembly 2 of the second embodiment is capable of good optical performance.

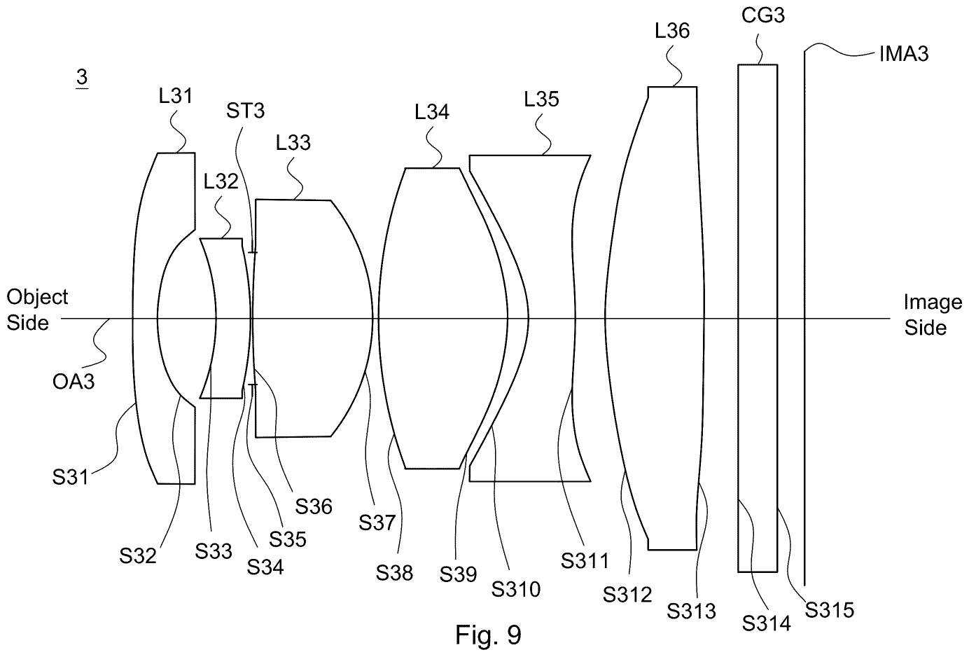

A detailed description of a wide-angle lens assembly in accordance with a second embodiment of the invention is as follows. Referring to FIG. 9, the wide-angle lens assembly 3 includes a first lens L31, a second lens L32, a stop ST3, a third lens L33, a fourth lens L34, a fifth lens L35, a sixth lens L36, and an cover glass CG3, all of which are arranged in order from an object side to an image side along an optical axis OA3. In operation, the light from the object side is imaged on an image plane IMA3.

According to the foregoing, wherein: both of the object side surface S31 and image side surface S32 of the first lens L31 are spherical surfaces; the second lens L32 is a meniscus lens, wherein the object side surface S33 is a concave surface and the image side surface S34 is a convex surface; the fifth lens L35 is a meniscus lens, wherein the image side surface S311 is a convex surface; the sixth lens L36 is a meniscus lens, wherein the image side surface S313 is a concave surface; and both of the object side surface S314 and image side surface S315 of the cover glass CG3 are plane surfaces; with the above design of the lenses, stop ST3, and at least one of the conditions (1)-(12) satisfied, the wide-angle lens assembly 3 can have an effective decreased total lens length, an effective increased field of view, an effective resisted environment temperature change, and an effective corrected aberration. The wide-angle lens assembly of the present invention can meet the basic operation requirements when it only satisfies condition (12), the first lens is with negative refractive power includes a concave surface facing the image side, the second lens is with refractive power, the third lens is a biconvex lens with positive refractive power, the fourth lens is with positive refractive power includes a convex surface facing the object side, the fifth lens is with negative refractive power, and the sixth lens is with refractive power.

Table 7 shows the optical specification of the wide-angle lens assembly 3 in FIG. 9.

TABLE 7
Effective Focal Length = 2.96 mm F-number = 2.30
Total Lens Length = 10.53 mm Field of View = 164.00 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S31 | 32.89 | 0.39 | 1.54 | 56.00 | −4.45 | L31 |
| S32 | 2.22 | 0.91 | | | | |
| S33 | −2.34 | 0.54 | 1.85 | 40.10 | −10.78 | L32 |
| S34 | −3.48 | 0.03 | | | | |
| S35 | ∞ | 0.01 | | | | ST3 |
| S36 | 9.76 | 1.88 | 1.62 | 63.30 | 3.37 | L33 |
| S37 | −2.46 | 0.09 | | | | |
| S38 | 5.43 | 2.02 | 1.54 | 56.00 | 3.38 | L34 |
| S39 | −2.43 | 0.33 | | | | |
| S310 | −1.33 | 0.73 | 1.65 | 21.50 | −2.84 | L35 |
| S311 | −5.67 | 0.47 | | | | |
| S312 | 4.43 | 1.53 | 1.54 | 56.00 | 9.25 | L36 |
| S313 | 34.76 | 0.55 | | | | |
| S314 | ∞ | 0.61 | 1.52 | 64.20 | | CG3 |
| S315 | ∞ | 0.43 | | | | |

In the third embodiment, the conic constant k and the aspheric coefficients A, B, C, D, E of each aspheric lens are shown in Table 8.

TABLE 8

| Surface | | | | | | |
|---|---|---|---|---|---|---|
| Number | k | A | B | C | D | E |
| S31 | 0 | 1.93E−02 | −3.11E−03 | 2.82E−04 | 0 | 0 |
| S32 | 1.97E+00 | 1.53E−02 | 6.32E−03 | −3.06E−03 | 0 | 0 |
| S33 | 0 | 1.70E−02 | 2.40E−03 | −1.34E−03 | 0 | 0 |
| S34 | 0 | 1.74E−02 | 1.66E−03 | 0 | 0 | 0 |
| S36 | 6.88E+01 | −1.73E−02 | −1.02E−03 | −6.19E−03 | 0 | 0 |
| S37 | 0 | −7.69E−04 | −7.64E−04 | −1.84E−05 | 0 | 0 |
| S38 | 0 | 1.96E−03 | −1.69E−03 | 2.97E−04 | 0 | 0 |
| S39 | 0 | 2.28E−02 | −4.31E−03 | 1.00E−03 | 0 | 0 |
| S310 | −1.96E+00 | 4.70E−02 | −1.95E−02 | 3.99E−03 | −3.24E−04 | 0 |
| S311 | 0 | 4.65E−02 | −6.14E−03 | 6.05E−04 | −3.13E−05 | 0 |
| S312 | −1.75E+01 | −3.11E−03 | 8.03E−04 | −3.39E−05 | 0 | 0 |
| S313 | 0 | −8.67E−03 | 4.56E−04 | 6.49E−05 | −5.20E−06 | 3.85E−08 |

Table 9 shows the parameters and condition values for conditions (1)-(12) in accordance with the third embodiment of the invention. It can be seen from Table 9 that the lens assembly 3 of the third embodiment satisfies the conditions (1)-(12).

TABLE 9

| T1 | 0.39 mm | T3 | 1.88 mm | T4 | 2.02 | mm |
|---|---|---|---|---|---|---|
| T5 | 0.73 mm | T6 | 1.53 mm | d12 | 0.91 | mm |
| d23 | 0.04 mm | d45 | 0.33 mm | d56 | 0.47 | mm |
| f1/f | −1.50 | f4/f | 1.14 | (T3 + T4)/TTL | 0.37 | |
| (d23 + d45)/TTL | 0.03 | (R11 + R12)/T1 | 90.01 | (R31 + R32)/T3 | 3.88 | |
| (R51 + R52)/T5 | −9.57 | TTL/d12 | 11.51 | TTL/d56 | 22.52 | |
| T4 + T5 + T6 | 4.29 mm | f/(d12 + d23) | 3.11 | FOV/f | 55.44 | degrees/mm |

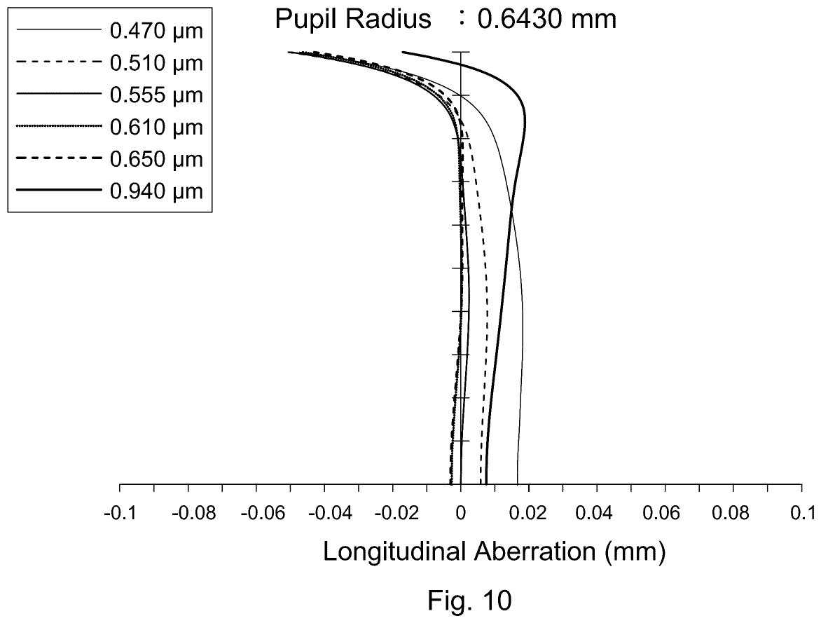

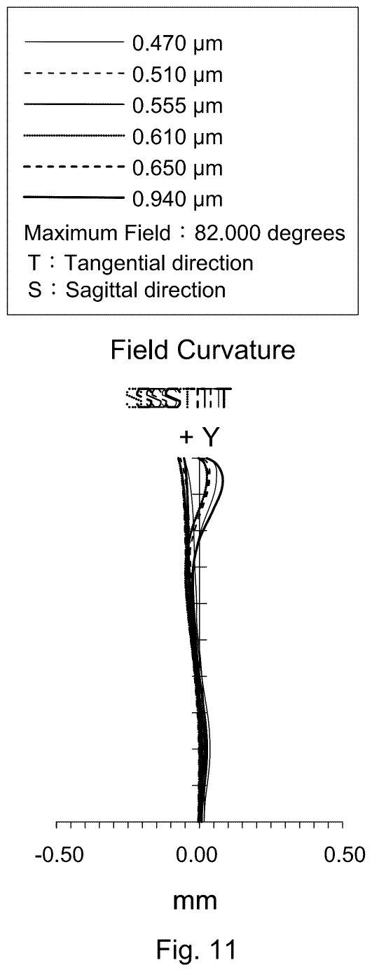

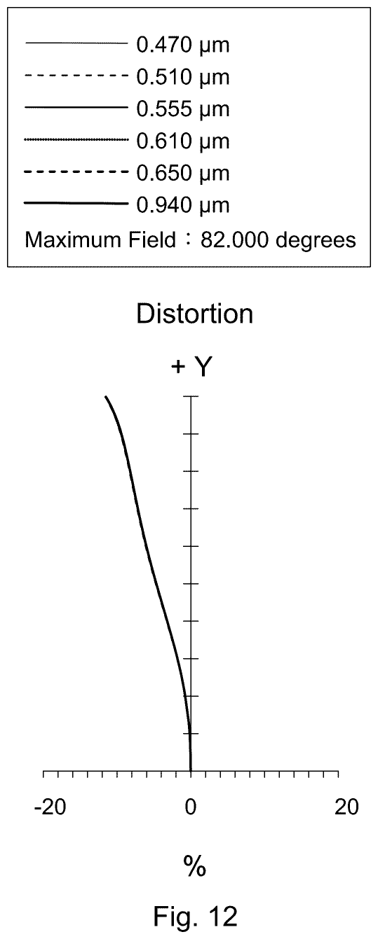

In addition, the wide-angle lens assembly 3 of the third embodiment can meet the requirements of optical performance as seen in FIGS. 10-12. It can be seen from FIG. 10 that the longitudinal aberration in the wide-angle lens assembly 3 of the third embodiment ranges from −0.05 mm to 0.02 mm. It can be seen from FIG. 11 that the field curvature of tangential direction and sagittal direction in the wide-angle lens assembly 3 of the third embodiment ranges from −0.1 mm to 0.1 mm. It can be seen from FIG. 12 that the distortion in the wide-angle lens assembly 3 of the third embodiment ranges from −12% to 0%. It is obvious that the longitudinal aberration, the field curvature, the distortion, and the lateral color can be corrected effectively and the resolution can also meet the requirements for the wide-angle lens assembly 3 of the third embodiment. Therefore, the wide-angle lens assembly 3 of the third embodiment is capable of good optical performance.

The wide-angle lens assemblies 1, 2, and 3 described above are configured such that an image plane position for the visible light spectrum is substantially identical to the image plane position for the infrared light spectrum. Furthermore, the wide-angle lens assemblies can maintain image clarity at both high and low temperatures, preventing image quality degradation caused by temperature fluctuations.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wide-angle lens assembly comprising:
a first lens with negative refractive power, which includes a concave surface facing an image side;
a second lens with refractive power;
a third lens which is a biconvex lens with positive refractive power and includes a convex surface facing an object side and another convex surface facing the image side;
a fourth lens with positive refractive power, which includes a convex surface facing the object side;
a fifth lens with negative refractive power; and
a sixth lens with refractive power;
wherein the first lens, the second lens, the third lens, the fourth lens, the fifth lens, and the sixth lens are arranged in order from the object side to the image side along an optical axis;
wherein the wide-angle lens assembly satisfies at least one of the following conditions:
$$50.59 \leq ( R 11 + R 12 ) / T 1 \leq 91.89 ;$$
$$- 10. 05 \leq ( R 51 + R 52 ) / T 5 \leq 0 \text{.51} ;$$
$$3.85 mm \leq T 4 + T 5 + T 6 \leq 4.41 mm ;$$
55.18 degrees/mm≤FOV/f≤60.73 degrees/mm;
wherein f is an effective focal length of the wide-angle lens assembly, T1 is an interval from an object side surface of the first lens to an image side surface of the second lens along the optical axis, T4 is an interval from an object side surface of the fourth lens to an image side surface of the fourth lens along the optical axis, T5 is an interval from an object side surface of the fifth lens to an image side surface of the fifth lens along the optical axis, T6 is an interval from an object side surface of the sixth lens to an image side surface of the sixth lens along the optical axis, R11 is a radius of curvature of the object side surface of the first lens, R12 is a radius of curvature of an image side surface of the first lens, R51 is a radius of curvature of the object side surface of the fifth lens, R52 is a radius of curvature of the image side surface of the fifth lens, and FOV is a full field of view of the wide-angle lens assembly.

2. The wide-angle lens assembly as claimed in claim 1, wherein the second lens is with negative refractive power, and the sixth lens is with positive refractive power.

3. The wide-angle lens assembly as claimed in claim 2, wherein:
the first lens is a meniscus lens and comprises a convex surface facing the object side;
the second lens is a meniscus lens;
the fourth lens is a biconvex lens and comprises a convex surface facing the image side;
the fifth lens comprises a concave surface facing the object side; and
the sixth lens comprises a convex surface facing the object side.

4. The wide-angle lens assembly as claimed in claim 3, wherein:
the second lens comprises a convex surface facing the object side and a concave surface facing the image side; and
the fifth lens is a biconcave lens and comprises a concave surface facing the image side.

5. The wide-angle lens assembly as claimed in claim 4, wherein the sixth lens is a biconvex lens and comprises a convex surface facing the image side.

6. The wide-angle lens assembly as claimed in claim 5, wherein the wide-angle lens assembly satisfies at least one of the following conditions:
$$- 1.55 \leq f 1 / f \leq - 1.2 ;$$
$$1.1 \leq f 4 / f \leq 1.6 ;$$
$$0.25 \leq ( T 3 + T 4 ) / TTL \leq 0 \text{.38} ;$$
$$0.005 \leq ( d 23 + d 45 ) / TTL \leq 0 \text{.04} ;$$
$$0.43 \leq ( R 31 + R 32 ) / T 3 \leq 4 \text{.05} ;$$
$$9.97 \leq TTL / d 12 \leq 11.71 ;$$
$$13.27 \leq TTL / d 56 \leq 26 \text{.79} ;$$
$$1.76 \leq f / ( d 12 + d 23 ) \leq 3 \text{.18} ;$$
wherein f is an effective focal length of the lens assembly, f1 is an effective focal length of the first lens, f4 is an effective focal length of the fourth lens, TTL is an interval from an object side surface of the first lens to the image plane along the optical axis, T3 is an interval from an object side surface of the third lens to an image side surface of the third lens along the optical axis, T4 is an interval from an object side surface of the fourth lens to an image side surface of the fourth lens along the optical axis, d12 is an air interval from an image side surface of the first lens to an object side surface of the second lens along the optical axis, d23 is an air interval from an image side surface of the second lens to the object side surface of the third lens along the optical axis, d45 is an air interval from the image side surface of the fourth lens to an object side surface of the fifth lens along the optical axis, and d56 is an air interval from an image side surface of the fifth lens to an object side surface of the sixth lens along the optical axis.

7. The wide-angle lens assembly as claimed in claim 4, wherein the sixth lens is a meniscus lens and comprises a concave surface facing the image side.

8. The wide-angle lens assembly as claimed in claim 7, wherein the wide-angle lens assembly satisfies at least one of the following conditions:
$$- 1.55 \leq f 1 / f \leq - 1.2 ;$$
$$1.1 \leq f 4 / f \leq 1.6 ;$$
$$0.25 \leq ( T 3 + T 4 ) / TTL \leq 0 \text{.38} ;$$
$$0.005 \leq ( d 23 + d 45 ) / TTL \leq 0 \text{.04} ;$$
$$0.43 \leq ( R 31 + R 32 ) / T 3 \leq 4 \text{.05} ;$$
$$9.97 \leq TTL / d 12 \leq 11.71 ;$$
$$13.27 \leq TTL / d 56 \leq 26 \text{.79} ;$$
$$1.76 \leq f / ( d 12 + d 23 ) \leq 3 \text{.18} ;$$
wherein f is an effective focal length of the lens assembly, f1 is an effective focal length of the first lens, f4 is an effective focal length of the fourth lens, TTL is an interval from an object side surface of the first lens to the image plane along the optical axis, T3 is an interval from an object side surface of the third lens to an image side surface of the third lens along the optical axis, T4 is an interval from an object side surface of the fourth lens to an image side surface of the fourth lens along the optical axis, d12 is an air interval from an image side surface of the first lens to an object side surface of the second lens along the optical axis, d23 is an air interval from an image side surface of the second lens to the object side surface of the third lens along the optical axis, d45 is an air interval from the image side surface of the fourth lens to an object side surface of the fifth lens along the optical axis, and d56 is an air interval from an image side surface of the fifth lens to an object side surface of the sixth lens along the optical axis.

9. The wide-angle lens assembly as claimed in claim 3, wherein:
the second lens comprises a concave surface facing the object side and a convex surface facing the image side; and
the fifth lens is a meniscus lens and comprises a convex surface facing the image side.

10. The wide-angle lens assembly as claimed in claim 9, wherein the sixth lens is a meniscus lens and comprises a concave surface facing the image side.

11. The wide-angle lens assembly as claimed in claim 10, wherein the wide-angle lens assembly satisfies at least one of the following conditions:
$$- 1.55 \leq f 1 / f \leq - 1.2 ;$$
$$1.1 \leq f 4 / f \leq 1.6 ;$$
$$0.25 \leq ( T 3 + T 4 ) / TTL \leq 0 \text{.38} ;$$
$$0.005 \leq ( d 23 + d 45 ) / TTL \leq 0 \text{.04} ;$$
$$0.43 \leq ( R 31 + R 32 ) / T 3 \leq 4 \text{.05} ;$$
$$9.97 \leq TTL / d 12 \leq 11.71 ;$$
$$13.27 \leq TTL / d 56 \leq 26 \text{.79} ;$$
$$1.76 \leq f / ( d 12 + d 23 ) \leq 3 \text{.18} ;$$
wherein f is an effective focal length of the lens assembly, f1 is an effective focal length of the first lens, f4 is an effective focal length of the fourth lens, TTL is an interval from an object side surface of the first lens to the image plane along the optical axis, T3 is an interval from an object side surface of the third lens to an image side surface of the third lens along the optical axis, T4 is an interval from an object side surface of the fourth lens to an image side surface of the fourth lens along the optical axis, d12 is an air interval from an image side surface of the first lens to an object side surface of the second lens along the optical axis, d23 is an air interval from an image side surface of the second lens to the object side surface of the third lens along the optical axis, d45 is an air interval from the image side surface of the fourth lens to an object side surface of the fifth lens along the optical axis, and d56 is an air interval from an image side surface of the fifth lens to an object side surface of the sixth lens along the optical axis.

12. The wide-angle lens assembly as claimed in claim 1, further comprising a stop disposed between the second lens and the third lens.

13. The wide-angle lens assembly as claimed in claim 1, wherein the wide-angle lens assembly satisfies at least one of the following conditions:
$$- 1.55 \leq f 1 / f \leq - 1.2 ;$$
$$1.1 \leq f 4 / f \leq 1.6 ;$$
$$0.25 \leq ( T 3 + T 4 ) / TTL \leq 0 \text{.38} ;$$
$$0.005 \leq ( d 23 + d 45 ) / TTL \leq 0 \text{.04} ;$$
$$0.43 \leq ( R 31 + R 32 ) / T 3 \leq 4 \text{.05} ;$$
$$9.97 \leq TTL / d 12 \leq 11.71 ;$$
$$13.27 \leq TTL / d 56 \leq 26 \text{.79} ;$$
$$1.76 \leq f / ( d 12 + d 23 ) \leq 3 \text{.18} ;$$
wherein f is an effective focal length of the lens assembly, f1 is an effective focal length of the first lens, f4 is an effective focal length of the fourth lens, TTL is an interval from an object side surface of the first lens to the image plane along the optical axis, T3 is an interval from an object side surface of the third lens to an image side surface of the third lens along the optical axis, T4 is an interval from an object side surface of the fourth lens to an image side surface of the fourth lens along the optical axis, d12 is an air interval from an image side surface of the first lens to an object side surface of the second lens along the optical axis, d23 is an air interval from an image side surface of the second lens to the object side surface of the third lens along the optical axis, d45 is an air interval from the image side surface of the fourth lens to an object side surface of the fifth lens along the optical axis, and d56 is an air interval from an image side surface of the fifth lens to an object side surface of the sixth lens along the optical axis.
